(19) United States
(12) Patent Application Publication
(10) Pub. No.: US 2008/0133587 A1
(43) Pub. Date: Jun. 5, 2008

(54) Extending Existing Data within a Directory Service

(76) Inventors: Krishna Ganugapati, Redmond, WA (US); Manuel Vellon, Bellevue, WA (US); Robert Amenn, Gold Bar, WA (US)

Correspondence Address: WHITAKER LAW GROUP, 755 WINSLOW WAY EAST, SUITE 304, BAINBRIDGE ISLAND, WA, 98110, US

(21) Appl. No.: 11/946,833

(22) Filed: Nov. 28, 2007

Related U.S. Application Data
(60) Provisional application No. 60/867,564, filed on Nov. 28, 2006.

(51) Int. Cl. G06F 17/30

(52) U.S. Cl. 707/103 R; 707/E17.055

(57) ABSTRACT

Additional data is associated with existing directory service object instances by creating instances of object classes in an Application Partition. The additional data is added to one or more attribute(s) of the created instances; the created instances are associated with existing object instances by setting the value of a backlink attribute in the created instances to be the same as a partition link value in the existing object instances. The created instances may be members of object classes which were already existing in the schema of the directory service, the created instances may be members of an existing object class which has attributes which are modified for this purpose, or the created instances may be members of a new object class created for this purpose. The additional data, backlink, and partition link values may be stored as a normal value for the chosen attribute(s) or as pseudo-values.

### STATEMENT OF RELATED APPLICATIONS

This application claims priority to copending provisional application titled, “Extending Existing Data within a Directory Service,” Ser. No. 60/867,564, filed on Nov. 28, 2006.

### SUMMARY OF THE INVENTION WITH BACKGROUND INFORMATION

This summary is provided to introduce a selection of concepts in a simplified form that are further described below in the detailed description. This summary is not intended to identify key feature or essential features of the claimed subject matter, nor is it intended to be used to limit the scope of the claimed subject matter.

Directory services (DS's) are used by organizations to store and organize information about users and computer resources distributed throughout their networks. This information is represented to users of the directory service as nodes on a hierarchy. Each node is an instance of an object class; object classes comprise at least a collection of attributes and the data types of the attributes. Values may be stored in the attributes; certain attributes may require a value to be stored whereas others permit a value to be stored. The schema of a DS is the definition of the object classes and associated attributes.

By way of example, a user may be represented in a DS as an instance of the object class “user.” This object class lists a collection of attributes that describe a user, such as “sn” which holds the surname of the user and “mobile” which holds the primary mobile phone number of the user. Each type of user or resource is represented in the DS as an instance of an object class.

DS's are used by software applications for a variety of purposes. Frequently, DS's are used for user authentication purposes. When a user enters a username and password into an application, the application may communicate with the DS to assure that the user's password is correct and that the user has sufficient privileges to run the application. DS's may also be used to administer and control access to and use of resources, such as file systems or prints.

Many modern directory services are based on the Lightweight Directory Access Protocol (LDAP). LDAP provides a hierarchical storage model to maintain information about users, computers and other entities. A common commercial directory service used by organizations is Active Directory® (“AD”), produced the Microsoft Corporation.

DS administrators are often reluctant to make schema modifications or to allow any other changes to be made that might affect the integrity of important directory service objects. There are several reasons for this reluctance. Schema modifications are frequently difficult to “undo” if anything goes wrong during the modification process. Poorly designed modifications can also impact DS performance. External dependencies may not be known and/or may be difficult to change. DS administrators might also be reluctant to allow applications to modify important data as may be found in “user” object instances. Software defects might accidentally result in data corruption that could severely impact system operations.

The art has not demonstrated a satisfactory method to associate additional data with existing object instances in a DS which accommodates the reluctance of DS administrators to change schemas or important directory service objects.

Generally stated, the disclosed invention is directed to variations of a method for associating additional information or data with existing DS object instances. The variations involve creating an “Application Partition” (defined further herein). One variation creates new instances of existing object classes in the Application Partition; the additional information is stored in the attributes of the new instances of the existing object classes. The schema of the DS in this variation is not modified. Another variation involves creating new object classes with attributes tailored to store the additional information and creating instances of the new object classes in the Application Partition; the additional information is stored in the attributes of the new instances of the new object classes. The schema of the DS in this variation is modified. The variations provide bi-directional mechanisms to associate the additional information with previously existing object instances without having to modify the previously existing object instances. Under the variations, the additional data may be stored as a normal value for the chosen attribute or as a pseudo-value (defined further herein). A newly created instance may be linked to a previously existing object instance by setting a “backlink” attribute (defined further below), such as the common name attribute, of the newly created instance to have a value associated with a “partition link” attribute (defined further below) of a previously existing object instance, such as the UUID attribute.

### BRIEF DESCRIPTION OF THE DRAWINGS

FIG. 1 is an example of a typical LDAP data hierarchy such as may be maintained by AD.

FIG. 2 is a functional block diagram of exemplary computing devices and some data structures and/or components thereof, wherein a DS has not yet been modified according to this disclosure.

FIG. 3 is a functional block diagram of exemplary computing devices and some data structures and/or components thereof, wherein a DS has been modified according to this disclosure.

FIG. 4 is an operational flow diagram generally illustrating steps consistent with certain aspects of the invention.

FIG. 5 is an operational flow diagram generally illustrating steps consistent with certain aspects of the invention.

FIG. 6 is a functional block diagram of exemplary computing devices and some data structures and/or components thereof.

### DETAILED DESCRIPTION

The following detailed description refers to the accompanying drawings. The same reference numbers in different drawings identify the same or similar elements. The following detailed description is for the purpose of illustrating embodiments of the invention only, and other embodiments are possible without deviating from the spirit and scope of the invention, which is limited only by the appended claims. Certain of the figures are labeled with terms associated with specific software applications or categories of software applications. The labels and the following discussion use these terms and related terms as examples and not as limitations. Equivalent functions may be provided by other software applications operating on general and/or specialty purpose devices. Thus, references in this document to a browser, a webserver, a directory service, or a database should be understood to describe any software application providing similar functions, operating on suitable hardware for such software application, and provided with suitable communication facilities. References to a “network” shall be understood to describe any suitable network capable of providing communication between the other components, such as but not limited to the Internet. The components depicted in the figures represent function groups; it should be understood that such function groupings need not exist as discrete hardware devices or software applications and that the functions described as occurring within, comprising, or being provided by a grouping may be provided within or by common or separate physical and/or logical hardware devices and software applications. The components within and comprising any of the function groupings may be regrouped in other combinations and certain of the functions and/or steps may be omitted or re-ordered without deviating from the spirit of the disclosed invention.

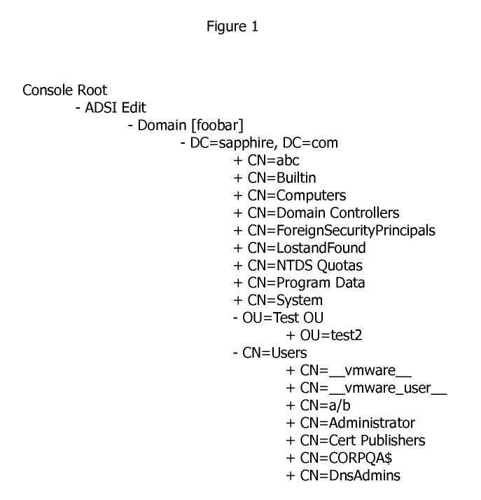

FIG. 1 is an example of a typical LDAP data hierarchy such as may be maintained by AD. Depicted in this drawing is a “domain,” [foobar]. Below the domain is a folder with two “DC” labels for “domain component,” the domain components being, in this example, “sapphire” and “com.” Below this folder are a series of folders which are either labeled “CN” for “common name” or “OU” for “organizational unit.” The node “CN=Computers” may hold nodes below it which maintain information about computer resources; the node “CN=Users” may hold nodes below it which maintain information about users, such as encrypted passwords. The node “CN=Program Data” may be used by applications and processes to maintain application and/or process specific information. This part of the hierarchical tree structure is referred to herein as the “Application Partition;” however, other node or nodes may be chosen or created to maintain application- or process-specific information and to serve as the Application Partition provided such node or nodes may be used by applications and processes to maintain application and/or process specific information. In an embodiment, the Application Partition may comprise a node or nodes which reside in the same part of the directory hierarchy as the object instances which the Application Partition nodes extend or add data to; in such an embodiment, the Application Partition may not be a specific branch within the DS hierarchy, but may comprise multiple branches and/or specific leaf nodes which are present throughout the DS tree structure.

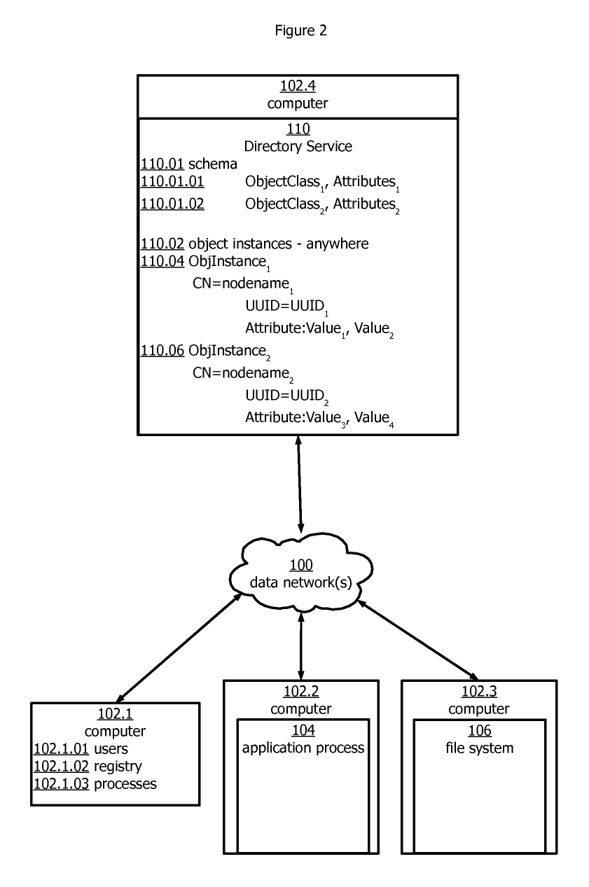

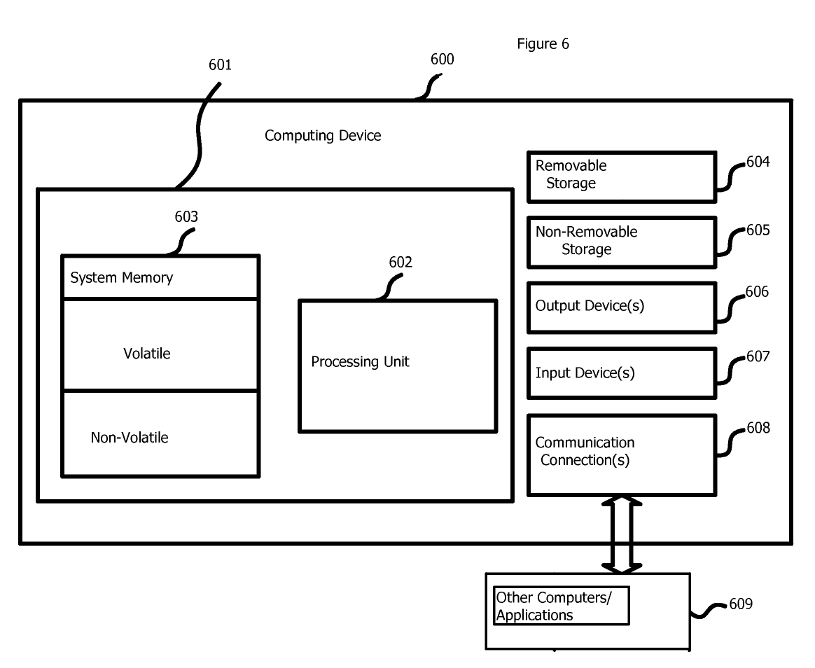

FIG. 2 is a functional block diagram of exemplary computing devices comprising certain labeled data structures and/or components, wherein a DS has not yet been modified according to this disclosure. FIG. 2 depicts one or more data networks 100, through which a plurality of computers communicate. The computers may be provided by a structure such as the one shown in FIG. 6, discussed further below. The computers in this figure are depicted as physically discrete entities, though they may only be logically discrete, the computer hardware being provided by common shared hardware.

Depicted is computer 102.4, which comprises a memory structure and processor configured with and executing a Directory Service 110. Also depicted is computer 102.1, which comprises a memory structure and processor configured with users 102.1.01, a registry 102.1.02, and executing application and non-application processes 102.1.03. Also depicted is computer 102.2 which comprises a memory structure and processor configured with and executing an application process 104. Also depicted is computer 102.3 which comprises a memory structure and processor configured with and executing a file system 106. The computers 102.1 through 102.3 and the users thereof and the processes being executed thereby may utilize the Directory Service 110 for various services, such as authentication and authorization, data storage and other services.

The Directory Service 100 is depicted as comprising a schema 110.01. The schema comprises the set of object classes which are allowed to have instances in the Directory Service 100. The object classes comprise a name for the object class as well as attributes and the data types of the attributes. The schema may define that attribute values may be allowed or required and that attributes may be allowed to have no value, a single value, or multiple values. The data types of the attributes may specify, for example, that data stored as a value of an attribute be an ASCII string of a certain length, binary digits occupying a certain number of bits, a hexadecimal value, that it be big or little endian, that the value occupy a fixed or a variable memory allotment, that the value contain a date, a telephone number, an email address, etc. In this example, ObjectClass₁, 110.01.01, has Attributes₁ while ObjectClass₂, 110.01.02, has Attributes₂. Attributes₁ and Attributes₂ may be entirely, partially, or not at all co-extensive. The Directory Service 100 is depicted as comprising object instances which may occur anywhere in the directory structure 110.02. Such object instances in this example comprise ObjInstance₁, 110.04, which has a common name attribute of “nodename₁,” a UUID attribute set to UUID₁, and one or more other attributes with values of Value₁ and Value₂. Such object instances in this example further comprise ObjInstance₂, 110.06, which has a common name of “nodename₂,” a UUID set to UUID₂, and one or more other attributes with values of Value₃ and Value₄. It should be noted that sequential numbering of these features is for convenience and the purpose of example only and that the values do not necessarily have to be different, the same, nor that values even need be present. It should also be noted that “UUID” stands for “Universally Unique Identifier” and should generally be understood in this disclosure to be synonymous with “GUID” or “Globally Unique Identifier.” It should also be noted that “UUID” and “common name” or “CN” may be referred to herein without necessarily being identified as an attribute.

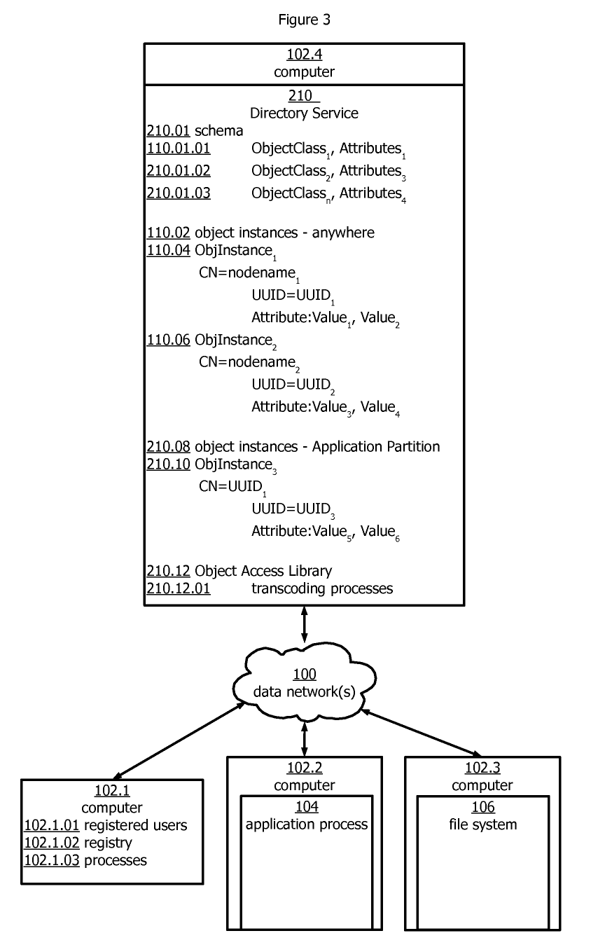

FIG. 3 is a functional block diagram of exemplary computing devices and some data structures and/or components thereof, wherein a DS has been modified according to this disclosure. Features with the same numbers as are found in other figures are meant to refer to the same feature. In addition to the features shown in FIG. 2, FIG. 3 depicts that existing ObjectClass₂ with Attributes₂ 110.01.02, has been modified to be ObjectClass₂ with attribute set Attributes₃ 210.01.02. In addition, FIG. 3 depicts a new object class, ObjectClassₙ, 210.01.03, with attribute set Attributes₄. The creation of this new object class is discussed further below. Because the schema has been modified as compared to the schema in FIG. 2, the schema in FIG. 3 is labeled 210.01. Also depicted in FIG. 3 are object instances in the Application Partition, 210.08. These object instances comprise ObjInstance₃, 210.10, which has a common name of “UUID₁,” a UUID set to UUID₃, and other attributes with values of Value₅ and Value₆. UUID₁ (the common name of ObjInstance₃, 210.10) is intended to be the same as or equivalent to (through transcoding performed by the “OAL,” discussed further below) the UUID of ObjInstance₁, 110.04.

Also depicted in FIG. 3 is an Object Access Library (“OAL”) 210.12, which comprises transcoding processes 210.12.01. The OAL is a software component that returns a software data structure that combines the data found in one or more DS object instances with “Additional Data” (which may be any new data) found in an associated object instance in the Application Partition. The transcoding processes 210.12.01 comprise instructions for transcoding data into a format compatible with an attribute, potentially including the addition of a prefix, suffix, or other label to the transcoded data. For example, data to be added may contain a 32-bit binary value which is meant to be a GID number (a group identifier for a Unix computer); the transcoding processes 210.12.01 may convert the data comprising the GID number into an ASCII string comprising “gidNumber=xxxxxx.” The ASCII string may then be stored as a value in an attribute which has an ASCII string data type. “gidNumber=xxxxxx” may not be customary value for the attribute and the attribute may not customarily be a container for GID numbers; nonetheless the attribute may be compatible with this value, such as a “description” attribute which may contain alphanumeric strings. The transcoding processes 210.12.01 may then further comprise instructions to parse “pseudo-value” attribute values and to perform reverse transcoding operations. For example, the transcoding processes 210.12.01, may parse the ASCII string attribute value comprising “gidNumber=xxxxxx;” the parser may identify “gidNumber=” in the attribute values and that this value is a condition which indicates that the following characters are a GID number; the mask may then remove this portion, leaving only “xxxxxx,” which ASCII value may then by type-converted into a 32-bit binary value. In this disclosure, a “pseudo-value” is an attribute value such as “gidNumber=xxxxxx” which is recognized by the Object Access Library 210.12 and/or by the transcoding processes 210.12.01 as a value which is to be or has been converted or transcoded, as described above.

The OAL 210.12 and/or the transcoding processes 210.12.01 may further be comprise instructions to search for corresponding backlinks and partition links (discussed further below), to obtain values from attributes associated with identified object instances, to perform reverse transcoding on obtained values, to combine obtained values (whether in a native format or following a reverse transcoding process) from one or more object instances, and to properly format the obtained and/or combined values as data and to return such data as one or more unified data structures.

The OAL 210.12 and the transcoding processes 210.12.01 may be provided by hard-coded instructions and/or by a table which comprises such instructions in the form of regular expressions or similar programming techniques. The transcoding and conversion of attribute values may be as simple as noting that a “fax number” attribute be handled as a “phone number” or as complex as a multi-stage compression algorithm; for performance reasons, the transcoding and conversion may be chosen to be computational efficient, such as a mask.

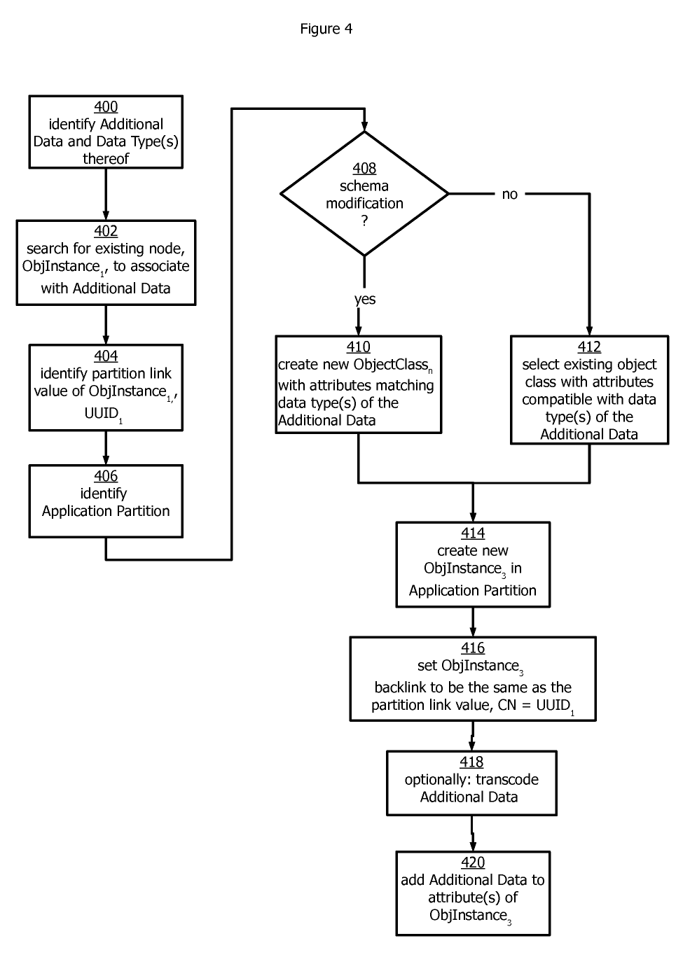

FIG. 4 is an operational flow diagram generally illustrating steps consistent with certain aspects of the invention, wherein Additional Data is associated with one or more existing object instances in a DS according to this disclosure. At step 400, the Additional Data and its data types are identified. If one or more existing object instance nodes which are to be associated with the Additional Data are not already known, then at step 402 a search is carried out to identify such an object instance; in the example depicted in FIG. 4, the search finds ObjInstance₁ 110.04 (ObjInstance₁ 110.04, is to be associated with the Additional Data). At step 404, the partition link value of ObjInstance₁ 110.04 is identified. The partition link value may be the value of an attribute, such as the UUID, which is known to the OAL 210.12 and/or the transcoding processes 210.12.01 to be the partition link value. Hereinafter, the “partition link value” may be referred to interchangeably with the value of a UUID attribute for a particular object instance; however, another attribute value may be used by the OAL 210.12 and/or the transcoding processes 210.12.01 as the partition link value instead of the UUID attribute without necessarily changing the function of the partition link value. In the example of ObjInstance₁ 110.04, the partition link value is UUID₁. At step 406, if the Application Partition is not already known, then the Application Partition is identified.

Step 408 depicts a decision junction in which it is decided whether or not the schema for the DS will be modified to accommodate the Additional Data, such as through the addition of a new object class, such as ObjectClassₙ, or through the modification of an existing object class, such as the modification of ObjectClass₂ with Attributes₂ 110.01.02 to be ObjectClass₂ with attribute set Attributes₃ 210.01.02. If the schema is to be modified, then at step 410, if the new object class has not yet been created to contain the Additional Data in its instances, then a new object class, ObjectClassₙ, is created with attributes which match or are at least compatible with the data type(s) of the Additional Data, such as the new object class ObjectClassₙ 210.01.03 discussed above; alternative to creating a new object class, an existing object class could be modified to include attribute(s) which match or are at least compatible with the data type(s) of the Additional Data, such as the modified object class ObjectClass₂ 210.01.02. If the schema is not to be modified, then at step 412, if an existing object class has not yet been selected to contain the Additional Data in its instances, then an existing object class is selected which has attributes which match or are at least can be made compatible with the data type(s) of the Additional Data (compatibility being provided, for example, by the OAL 210.12 and/or the transcoding process 210.12.01). When creating a new object class, the DS administrator may have greater flexibility to assign an attribute set to the new object class, which attribute set matches the data type(s) of the Additional Data; however, it may be possible to nonetheless create a new object class with an attribute set which is merely compatible with the data type(s) of the Additional Data, meaning that the values found associated with the attributes in a specific object instance may be converted by the OAL 210.12 and/or the transcoding processes 210.12.01, as described above.

At step 414, a new object instance, ObjInstance₃, 210.10, is created in the Application Partition. At step 416, the backlink for ObjInstance₃ is set to be the same as the UUID of ObjInstance₁, which was identified at step 404 as UUID₁. The backlink is an attribute of an object instance in the Application Partition which is known to the OAL 210.12 and/or the transcoding process 210.12.01 to be a backlink; in this disclosure, the backlink attribute may be the common name attribute, though in another embodiment a different attribute may be used as the backlink without necessarily changing the function of the backlink. “Backlink” and “common name” may be used interchangeably in this disclosure when the value of the “common name” attribute is equal to the value of a partition link. In the example here, the common name of ObjInstance₃ is set to be UUID₁. Step 404 could be performed at any time prior to step 416. Step 418 depicts an optional step wherein the Additional Data is transcoded as described above; such transcoding may be performed by the OAL 210.12 and the transcoding processes 210.12.01. Step 420 depicts then setting some or all of the value(s) of the attributes of ObjInstance₃ to be the values of the Additional Data; certain of such values may be transcoded pseudo-values. By adding the Additional Data to object instances in the Application Partition, the existing DS—outside of the Application Partition—may remain unmodified; by adding the Additional Data to an existing object class as pseudo-values, even the DS schema remains unmodified.

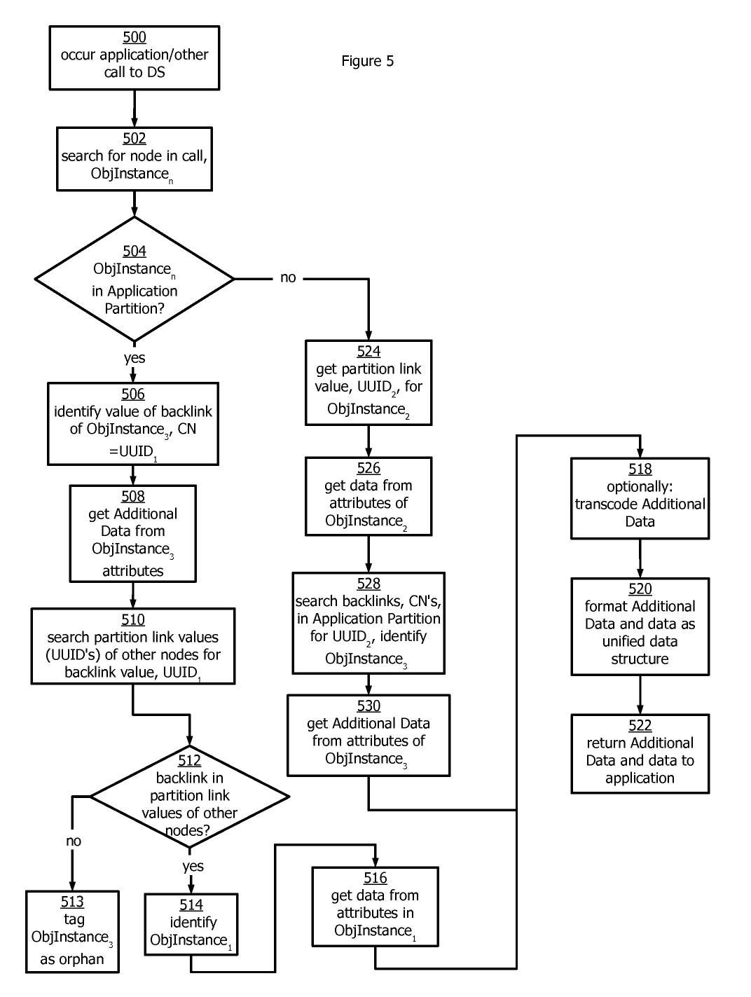

FIG. 5 is an operational flow diagram generally illustrating steps consistent with certain aspects of the invention, wherein Additional Data is obtained from a DS after the Additional Data was added to the DS, such as according to the steps depicted in FIG. 4. At step 500, a call occurs to the DS. The call may originate from a login by a user, such as 102.10.01, it may originate from an event associated with a registry, such as 102.10.02, or associated with a process or application process, such 102.1.03, 104, or 106. The call may identify an object instance by an attribute which is commonly used as an identifier, such as a UUID and/or a common name, the call may include one or more identifiers for parent node(s), and/or the call may identify an object instance by otherwise providing a value(s) which is(are) believed to be associated with an attribute(s) of an object instance. At step 502, the node identified in the call, ObjInstanceₙ, is searched for; if the call provides sufficient information and if the validity of the call is not in question, then the search for the node may be omitted.

At step 504, a decision junction depicts determining whether the object instance ObjInstanceₙ is in the Application Partition. If the object instance is in the Application Partition, then at step 506 the value of the backlink of the object instance is obtained. In this example, the object instance had been found at step 502 to be ObjInstance₃, the backlink in the Application Partition is the common name, and the common name in this instance was found to be UUID₁. Obtaining the value of the backlink of the object instance may include reverse transcoding the value. At step 508, the Additional Data is obtained from the attributes of ObjInstance₃. At step 510, the partition link values (the UUID's in this example) of other nodes are searched for the common name or backlink value which was identified at step 506; in this example, the search is for UUID, which is the common name and backlink value of ObjInstance₃.

A decision junction 512 represents this possibility that the backlink value (in this example the common name of ObjInstance₃, UUID₁) for the object instance in the application partition may or may not be found. If the backlink is not found, then at step 513 the object instance in the application partition, ObjInstance₃, is tagged as an orphan, in the sense that an object instance with a backlink has been found in the application partition which does not have a corresponding object instance outside of the application partition with a matching partition link. Object instances which are tagged as orphans may be deleted, may be ignored, and/or may be sent for further analysis by other processes or people. If the backlink value or common name, UUID, for the object instance is found in the UUID's of other object instances outside of the Application Partition, then step 514 depicts a step of identifying the corresponding object instance, in this example ObjInstance₁. Step 516 then depicts an optional step of obtaining data from the attributes of ObjInstance₁.

If at decision junction 504 the ObjInstanceₙ was found to be ObjInstance₂ and was thus not found to be in the Application Partition, then step 524 depicts getting the partition link value (in this example, the UUID) for ObjInstance₂, which in this example is UUID₂. Step 526 depicts getting data from the attributes of ObjInstance₂. Step 528 depicts searching the backlinks (in this example, the common names) of nodes in the Application Partition for the partition link value, UUID₂; in this example, such a search identifies ObjInstance₃. Step 530 depicts getting Additional Data from the attributes of ObjInstance₃.

Step 518 depicts optionally transcoding the Additional Data which was obtained from the attributes of ObjInstance₃. The transcoding may comprise processing the Additional Data according to the transcoding processes 210.12.01, discussed above. Step 520 depicts combining the Additional Data obtained from ObjInstance₃ and the data from ObjInstance₁ or ObjInstance₂ and/or formatting it as a unified data structure responsive to the call of step 500, which combining and/or formatting may be performed by the transcoding processes 210.12.01, discussed above. Step 522 then depicts returning the Additional Data and the data to the process which made the call of step 500.

FIG. 6 is a functional block diagram of an exemplary computing device 600 that may be used to implement one or more computers described above. The computing device 600, in one basic configuration, comprises at least a processor 602 and memory 603. Depending on the exact configuration and type of computing device, memory 603 may be volatile (such as RAM), non-volatile (such as ROM, flash memory, etc.) or some combination of the two.

Computing device 600 includes one or more communication connections 608 that allow computing device 600 to communicate with one or more computers and/or applications 609. Device 600 may also have input device(s) 607 such as a keyboard, mouse, digitizer or other touch-input device, voice input device, etc. Output device(s) 606 such as a monitor, speakers, printer, PDA, mobile phone, and other types of digital display devices may also be included. These devices are well known in the art and need not be discussed at length here.

Additionally, device 600 may also have other features and functionality. For example, device 600 may also include additional storage (removable 604 and/or non-removable 605) including, but not limited to, magnetic or optical disks or tape. Computer storage media includes volatile and nonvolatile, removable and non-removable media implemented in any method or technology for storage of information such as computer readable instructions, data structures, program modules or other data. Memory 603, removable storage 604 and non-removable storage 605 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 600. Any such computer storage media may be part of device 600.

1. A method of adding data to a directory service, the directory service comprising a schema, an application partition and an object access library, the method comprising the following steps:
identifying and/or obtaining the data to be added and the data type(s) thereof;
identifying and/or obtaining at least one object instance to associate with the data to be added;
obtaining the partition link value of at least one identified object instance;
creating an object instance in the application partition;
setting the backlink of the created object instance in the application partition to be equal to the obtained partition link value of the at least one identified object instance;
adding the data to be added as one or more values of one or more attributes associated with the created object instance in the application partition.

2. The method according to claim 1 where the backlink of the created object instance in the application partition is an attribute value associated with the created object instance.

3. The method according to claim 2 where the attribute value associated with the created object instance is the common name of the created object instance.

4. The method according to claim 2 where the attribute value associated with the created object instance is a pseudo-value.

5. The method according to claim 1 where the partition link value is the UUID of the at least one identified object instance.

6. The method according to claim 1 where the partition link value is a pseudo-value of the at least one identified object instance.

7. The method according to claim 1 further comprising transcoding the data to be added to be data in a pseudo-value form.

8. The method according to claim 1 where the object instance created in the application partition is an instance of an object which existed in the schema prior to the addition of data to the directory service.

9. The method according to claim 1 where the object instance created in the application partition is an instance of either.
a new object which did not exist in the schema prior to the addition of the data to the directory service, which new object has an attribute which is used to store a value containing the data to be added; or
an instance of an existing object in the schema which existing object is modified to include an attribute new to the object, which new attribute is used to store a value containing the data to be added.

10. A computer readable medium comprising thereon instructions which, when executed, perform steps according to the method of claim 1.

11. A method of obtaining data from a directory service, the directory service comprising an application partition and an object access library, the method comprising the following steps.
receiving a call to the directory service, which call comprises an identifier associated with an object instance;
searching for a first object instance associated with an identifier;
if the first object instance is in the application partition,
then
getting the backlink of the first object instance,
searching partition link value of object instances outside of the application partition for a partition link value which is the same as the backlink of the first object instance and, if such an object instance is found, identifying a second object instance;
else
getting the partition link value for the first object instance,
searching backlink of object instances in the application partition for a backlink which is the same as the partition link value of the first object instance and, if such an object instance is found, identifying a second object instance;
getting a first data from the attributes of the first object instance;
getting a second data from the attributes of the second object instance;
returning the first and/or second data as a response to the call to the directory service.

12. The method according to claim 11, where if there is no object instance outside of the application partition which has a partition link value which is the same as the backlink of the first object instance, then labeling the first object instance as an orphaned object instance.

13. The method according to claim 11, where the backlink is an attribute value.

14. The method according to claim 13, where the attribute of the attribute value is the common name attribute of the object instance.

15. The method according to claim 13, where the attribute value is a pseudo-value of the object instance.

16. The method according to claim 11, where the partition link value is an attribute value.

17. The method according to claim 16, where the attribute of the attribute value is the UUID attribute of the object instance.

18. The method according to claim 16, where the attribute value is a pseudo-value of the object instance.

19. The method according to claim 11, further comprising transcoding data from a pseudo-value format.

20. A computer readable medium comprising thereon instructions which, when executed, perform steps according to the method of claim 11.

21. A computer system to provide a directory service comprising the following components.
a memory structure configured to store object instances;
a directory service component comprising a schema of object classes and an object access library component, wherein the directory service component further comprises instructions which, when executed.
identify and/or obtain data to be added to the memory structure configured to store object instances and the data type(s) thereof;
identify and/or obtain at least one object instance to associate with data to be added;
obtain the partition link value of at least one identified object instance;
creates an object instance in the application partition;
sets the backlink of the created object instance in the application partition to be equal to the obtained partition link value of the at least one identified object instance;
adding the data to be added as one or more values of one or more attributes associated with the created object instance in the application partition.
receive a call to the directory service, which call comprises an identifier associated with an object instance;
searches for a first object instance associated with an identifier received in a call;
if the first object instance is in the application partition,
then
gets the backlink of the first object instance,
searches the partition link value of object instances outside of the application partition for a partition link value which is the same as the backlink of the first object instance and, if such an object instance is found, identifies a second object instance;
else
gets the partition link value for the first object instance,
searches backlink portions of object instances in the application partition for a backlink which is the same as the partition link value of the first object instance and, if such an object instance is found, identifies a second object instance;
gets a first data from the attributes of the first object instance;
gets a second data from the attributes of the second object instance;
returns the first and/or second data as a response to the call to the directory service.

22. The system according to claim 20, wherein the object access library further comprises instructions comprising transcoding processes which, when executed, transcode data to be added into a pseudo-value format and/or transcode a first and/or second data from a pseudo-value format.

23. The system according to claim 20, wherein the object access library further comprises instructions which, when executed, determine if there is no object instance outside of the application partition which has a partition link value which is the same as the backlink of the first object instance, and, if so, then labels the first object instance as an orphaned object instance.
